(19) United States
(12) Patent Application Publication
(10) Pub. No.: US 2018/0192820 A1
(43) Pub. Date: Jul. 12, 2018

(54) MULTI LEVEL CONFIGURABLE COUNTERTOP ROASTER OVEN

(71) Applicant: Peter Chung-Yuan Chang, San Diego, CA (US)

(72) Inventor: Peter Chung-Yuan Chang, San Diego, CA (US)

(21) Appl. No.: 15/870,645

(22) Filed: Jan. 12, 2018

Related U.S. Application Data
(60) Provisional application No. 62/445,685, filed on Jan. 12, 2017.

(51) Int. Cl. A47J 37/06

(52) U.S. Cl. CPC A47J 37/0629; A47J 37/04; A47J 37/0664

(57) ABSTRACT

A countertop roaster is configured for stacked or apparatus for multilevel cooking of food. The roaster has a first housing having a first sidewall surrounding a first cooking cavity and a a second housing having a bottom surface extending to a second sidewall surrounding a second cooking cavity. The roaster is configured for use with the first housing alone, or in a stacked configuration with a second housing atop the first housing where different foods can be cooked respectively in said first cooking cavity and said second cooking cavity with heat communicated from an electric heating element in said first housing.

This application claims priority to U.S. Provisional Patent Application, Ser. No. 62/445,685 filed on Jan. 12, 2017, which is incorporated herein in its entirety by this reference thereto.

### FIELD OF THE INVENTION

The present device relates to roaster ovens used on household countertops to roast or bake food. More particularly, the disclosed device relates to a countertop roaster oven which is configurable to include and cook upon multiple levels for concurrent cooking respective different foods upon each level, or which is reconfigurable to a single level roaster oven.

### BACKGROUND OF THE INVENTION

The use of countertop-situated roaster ovens have become more popular in kitchens throughout the United States and many foreign countries. Such roaster ovens are generally situated on a countertop and have a cord which plugs into an electrical socket to provide power for the roasting or baking process.

Indeed, such roaster ovens are frequently employed to roast turkeys or roasts and can also be used to bake biscuits or in some cases bread. Conventionally, such roaster ovens will have a recessed cavity for positioning of the food therein and a lid to cover the cooking food while roasting or baking within the roaster oven.

In use, conventional roaster ovens have a cavity deep and wide enough to accommodate larger types of food to be cooked, such as a turkey or a roast or the like. The user will position the meat or fowl, or the like, to be cooked within the deep cavity formed by a sidewall of the cooking housing. In some cases, the interior cavity has a removable pan which allows for the food to be cooked therein. After the cooking is finished, the pan may be removed for serving the food and also for cleaning of any baked or roasted on food.

However, conventional countertop roasters are limited in function due to the conventional configuration of a single recessed cooking cavity within a surrounding housing, which is then covered by a lid. Where a roast or bird is being cooked within such a single cavity with the lid engaged, no other food can generally be cooked at the same time, lest it be saturated with juices from the cooking meat or fowl, or burned by the high heat used for such cooking, when a lower temperature is required.

Consequently, users are required to use another cooking device such as a large oven, or a toaster oven, or multiple pans on a stove, to cook the other ingredients to be served with the main course cooking in the roaster oven. The use of such multiple cooking devices is a waste of energy. Further, it does not allow the cook to place multiple items into the countertop roaster for concurrent cooking of all the different foods along the same duration of time, and thereby have the entire meal cooked by a single device in a single time period where all the food is ready to eat at one time.

The device herein provides a countertop roaster oven which is configurable for use in a conventional fashion with one level of cooking when desired, and is also easily reconfigured to cook different foods segregated on multiple levels in different closed cavities concurrently. The device herein so configured for elevational cooking cavities thereby allows the chef to cook all or a majority of the food of different types for a meal, concurrently with one device. In such a stacked configuration, the device herein is configurable to cook each of a plurality of foods for a meal, in one respective multiple level concurrently, rather than being relegated to cooking in a single cooking cavity on one level.

The forgoing examples of related art of countertop roaster ovens, and limitations related therewith, are intended to be illustrative and not exclusive, and they do not imply any limitations on the invention described and claimed herein.

Various other limitations of the related art are known or will become apparent to those skilled in the art upon a reading and understanding of the specification below and the accompanying drawings.

### SUMMARY OF THE INVENTION

The device and system herein disclosed and described provides a solution to the shortcomings in prior art of countertop roaster ovens and achieves the above noted objects through the provision of a stackable, multi-configurable countertop roaster oven. In differing configurations employing a support ring, the device allows for cooking food in a conventional fashion of such countertop roaster ovens on one level, but in a reconfigured mode provides an elevated cavity allowing a configuration to cook each of a plurality of multiple foods on one of multiple levels, concurrently.

The disclosed device features a first housing having a sidewall surrounding a first cooking cavity. The first housing employs a conventional electric heating element mounted therein to communicate heat at the appropriate temperature, into the first cooking cavity. These heating elements are powered by conventional electricity communicated to the heating elements in the housing by a socket engaging electric cord and need not be depicted as they are well known in the art.

A timer may be provided for the user to set time durations for cooking cycles of the device, along with a thermostat which may be interfaced with the cooking elements heating the first cooking cavity, to operate them for durations and energy levels to maintain a user determined temperature in the first cooking cavity. A lid is provided to maintain a cover over this first cooking cavity during cooking cycles.

Additionally provided, to allow the user at will to configure the device to a stacked configuration forming a multi level cooker, with multiple cooking containers on differing levels, are a support ring. This support ring is sized to engage the upper perimeter edge of the sidewall of the housing surrounding the first cooking cavity. The support ring has a bottom surface adapted for a sealed engagement against this perimeter edge of the sidewall of the housing. The support ring has an aperture formed therein and has an upper surface with an annular recess therein surrounding the aperture. This annular recess is sized to engage and support, a surface of a lower perimeter edge of a second cooking cavity, in a seated and secure position atop the support ring and centered over the aperture.

The annular recess formed to support the lower surface of the second cooking cavity, surrounds the aperture which communicates through the support ring. This aperture provides a pathway for a communication of heat rising from the first cooking cavity in the housing, to a contact and communication with a bottom surface of the second cooking cavity. The bottom surface of the second cooking cavity when operatively positioned in contact atop the support ring within the annular recess, concurrently forms a sealed lid atop the support ring, for the first cooking cavity.

Thus, with the support ring operatively engaged upon the upper perimeter edge of the sidewall of the housing surrounding the first or lower cooking cavity, and the lower perimeter edge of the second cooking cavity seated in the annular recess, the bottom wall of the second cooking cavity forms a lid in a sealed engagement with the first cooking cavity. This bottom wall is preferably formed of metal which conducts the heat rising from the first cooking cavity, and thereby transmits that heat through the bottom wall by conduction, and into the second cooking cavity.

The second cooking cavity has a size or volume defined by an interior surface of a surrounding sidewall of the second cooking cavity, and the interior surface of the bottom wall. It may be smaller or larger than the first cooking cavity. The lid normally engaged on top of the first cooking cavity to seal it, is also adapted for a sealed engagement atop this second cooking cavity. The user thus may employ the device with only the first cooking cavity and the lid sealed thereon, or may reconfigure the device to a stacked cooking configuration by positioning the support ring atop the sidewall of the first cooking cavity, engaging the bottom perimeter edge of the second cooking cavity with the annular recess of the support ring, and then placing the lid in a sealed engagement with the perimeter edge of the upper end of the sidewall of the second cooking cavity.

So configured in the multilevel configuration, the user may at any time remove the support ring while it is engaged with the second cooking cavity and lid to provide access to the first cooking cavity. Further, the user can get access to the second cooking cavity by simply removing the lid therefrom.

The first cooking cavity may be filled with a first food to be cooked, and the second cooking cavity may be filled with a second food to be cooked. In a particularly preferred mode of the device, a secondary cooking container having separate cooking recesses formed therein, may be engaged about a projecting perimeter edge, with a mounting recess formed along the top perimeter edge of the sidewall of the second cooking cavity. Such will provide two or more additional cooking recesses to hold two other types of food, elevated above a lower portion of the second cooking cavity, and heated by heat rising therefrom. The lid is adapted to sealably engage over the secondary cooking container and second cooking cavity.

With respect to the above description, before explaining at least one preferred embodiment of the herein disclosed multilevel countertop roaster invention in detail, it is to be understood that the invention is not limited in its application to the details of construction and to the arrangement of the components in the following description or illustrated in the drawings. The multilevel roaster invention herein described and shown is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other multilevel Countertop roaster structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the present invention to provide a highly efficient countertop roaster which may be employed in single level for cooking or a stacked configuration enabling multilevel cooking.

It is an additional object of this invention to provide such a countertop roaster which will allow a user to concurrently cook, in separate cooking cavities and recesses, each of a respective one of multiple foods.

These and other objects, features, and advantages of the present countertop roaster invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed device and system. It is intended that the embodiments and figures disclosed herein are to be considered illustrative of the invention herein, rather than limiting in any fashion. In the drawings:

FIG. 1 depicts the device configured for single level cooking in the first cooking cavity located in a housing, and having the lid engaged atop the perimeter of the sidewall the housing.

FIG. 2 shows the device in a stacked configuration, configured for multilevel cooking, where a second housing with a second cooking cavity has been operatively engaged with the top surface of s support ring which has a bottom surface in sealed engagement with the top of the sidewall of the housing, and showing the lid operatively sealed upon the perimeter of the upper end of the sidewall of the second housing having the second cooking cavity.

FIG. 3 displays an exploded view of the removably engageable components of the countertop roaster device which are configurable by a user to the device as in FIG. 1, or FIG. 2.

FIG. 4 depicts another exploded view of the components of the Countertop roaster device herein.

### DETAILED DESCRIPTION OF THE INVENTION

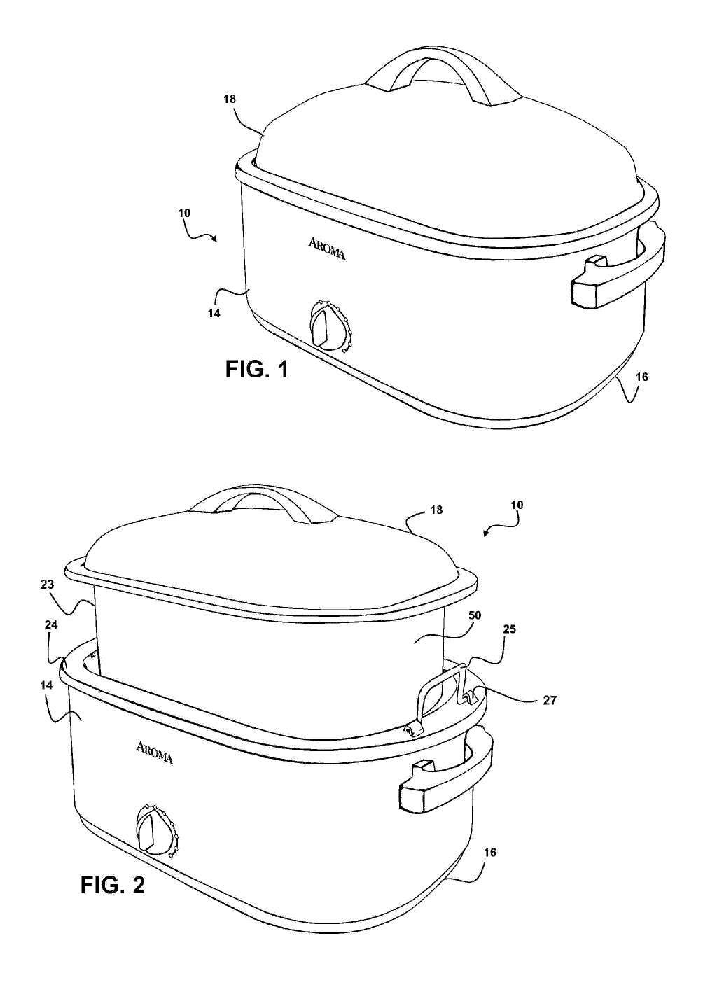

The device 10 and system herein disclosed and described in FIGS. 1-4 provide a solution to the shortcomings in prior art of countertop single level cooking roaster ovens. As can be seen in FIG. 1, the device 10 is configurable to a first configuration, which cooks food on a single level, in a first cooking cavity 12. This first cooking cavity 12 is defined by the interior surface of a sidewall 14 of a first housing 16 which has conventional electric heating elements mounted therein to communicate heat at the appropriate temperature, into the first cooking cavity 12. As noted such heating elements are well known in the art and need not be depicted.

A lid 18 is provided to seal upon the sidewall 14 of the first housing 16 to cover and seal the first cooking cavity 12 during cooking cycles. As noted above, this lid 18 is also configured to form a sealed engagement over the second cooking cavity 20 of a stacked second housing 23. A liner 22 may be provided which inserts into the first cooking cavity 12 or may also be provided to allow for removal and cleaning of the cooking surface.

The device 10 also includes components allowing the user to configure the device 10 to a stacked configuration such as depicted in FIG. 2, to cook multiple different foods separated in multiple cavities aligned on multiple levels. To that end, a support ring 24 shown having handles 25 is provided. The support ring 24 is configured on a bottom or first side surface 26 to form a first sealed engagement with the upper perimeter edge 28 of the sidewall 14 of the first housing 16, which would be the upper perimeter edge 28 of the liner 22 when inserted into the first cooking cavity 12.

This support ring 24 is configured on an upper or second surface 30 to form a second sealed engagement in a contact with a lower perimeter edge 32 of the second housing 23 surrounding the second cooking cavity 20. This second sealed engagement may be enhanced with an annular recess 34 shaped and sized to engage and support the lower perimeter edge 32 of the second housing 23 surrounding the second cooking cavity 20, in a seated and secure position atop the support ring 24. The annular recess 34 by having a shape and size which mirrors that of the lower perimeter edge 32 of the second cooking cavity 20, forms slide lock connection therebetween which prevents sliding of the second housing 23 atop the support ring 24 and is preferred to prevent accidental dismount of the second housing 23 when the device 10 is in the stacked configuration of FIG. 2.

The annular recess 34 depends into and surrounds an aperture 36 of the support ring 24. This aperture 36 which communicates through the support ring 24, defines a pathway to communicate heat rising from the first cooking cavity 12 to heat a bottom surface 38 of the second housing 23 having the second cooking cavity 20 when the second housing 23 is seated on the support ring 24. This bottom surface 38 in combination with the sealed engagement of the lower perimeter edge 32 of the second housing 23 having the second cooking cavity 20, with the upper or second surface 30 of the support ring 24, forms a secondary lid upon the first cooking cavity 12 when the device is in the stacked or multilevel configuration of FIG. 2.

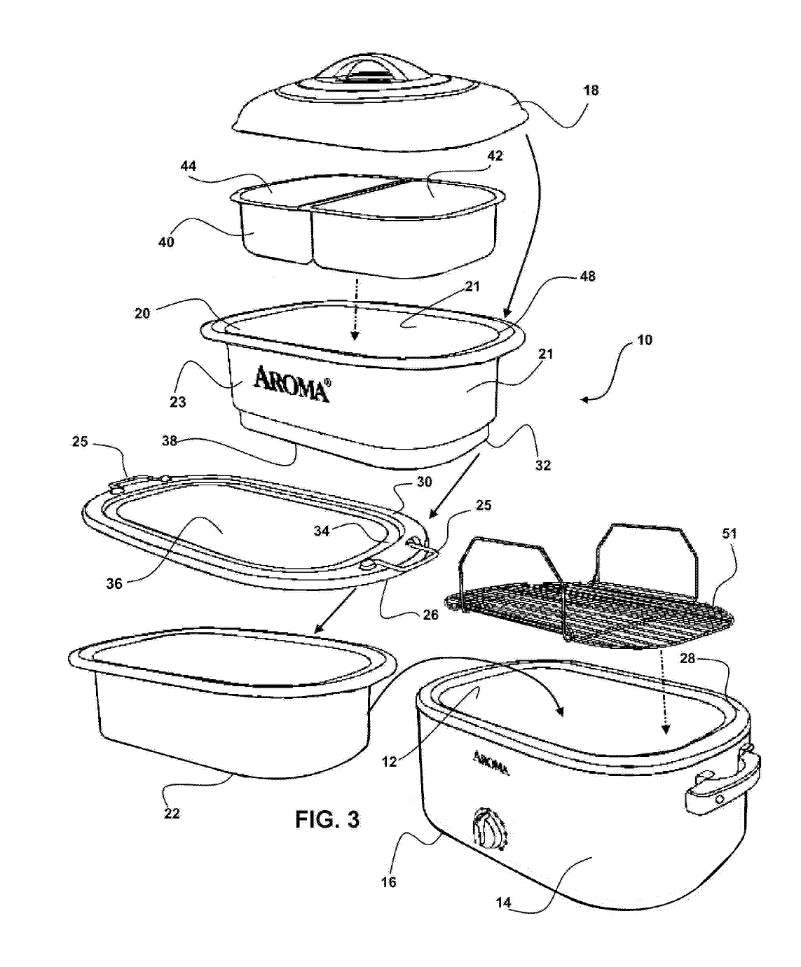

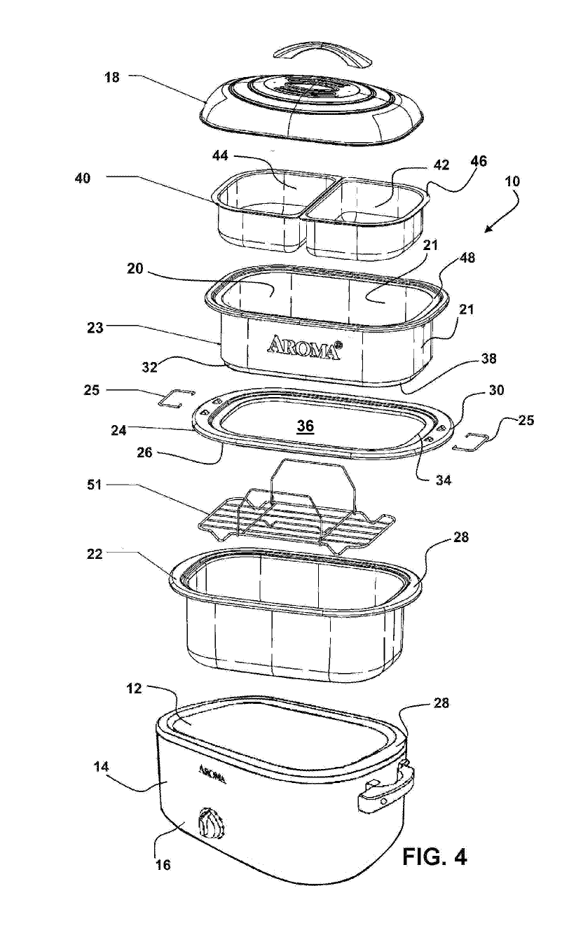

The different components of the device 10 and their respective positioning and engagement can be discerned in FIGS. 3-4. As can be seen, the second housing 23 has a second cooking cavity 20 with a size or volume defined by an interior surface of a surrounding second sidewall 21 of the second housing 23 and the bottom surface 38 thereof. As also can be seen, the lid 18 which engages on top of the first cooking cavity 12 as in FIG. 1 to seal it, is also configured to form a sealed engagement atop the second housing 23 and over the second cooking cavity 20 as in FIG. 2 in the stacked or multilevel configuration.

In this multilevel configuration, the user may at any time remove the support ring 24 using the handles 25 while it is engaged with the second cooking cavity 20 and lid 18, to provide access to the first cooking cavity 12. While it was thought such handles 25 were not needed and the user could simply lift the support ring 24 on the sides, such did not work well when the support ring 24 was heated, and did not provide an easy grip point for the user to lift the support ring to different elevations and balance the support ring 24 with the second housing 23 sitting thereon. As such, the inclusion of the handles 25 which are in rotational engagements 27 on opposite sides of the support ring 24 are preferred to provide heat insulation and a more balanced handling. It was found that rotationally engaging the handles 25 not only reduced the heat communicated to them from the support ring 24, the rotation gave the user an easier grip with both hands as the elevation of the support ring 24 changed, versus fixed position handles 25. Also, while in the multilevel configuration, the user can get access to the second cooking cavity 20 by simply removing the lid 18 off of the engagement over the top of the second housing 23.

As noted, in a particularly preferred mode of the device 10, a secondary cooking container 40 have two or more separate cooking recesses 42 and 44 formed therein, can be positioned into the second cooking cavity 20 by seating a projecting perimeter edge 46 into a mounting recess 48 formed along the top perimeter edge of the second sidewall 21 of the second housing 23 surrounding the second cooking cavity 20. Such will provide at least two additional cooking recesses 42 and 44 to hold two other types of food, elevated above a lower portion of the second cooking cavity 20, to be heated by heat rising therefrom. The device 10 can also be provided with a support rack 51 which is insertable within the first cooking cavity 12 or the liner 22 therefor or within the second cooking cavity 20 to hold food above the bottom thereof and allow for easy removal.

As can be discerned, the device in the stacked or multilevel configuration of FIG. 2, can be employed to concurrently cook one type of food in the first cooking cavity 12 and separated therefrom in a second cooking cavity 20 the user can concurrently cook a second type of food. If the user wishes to cook additional types of food in separated areas from the first and second cooking cavities concurrently, the secondary cooking container 40 may be inserted and two or more other foods may be concurrently cooked in the plurality of cooking recesses 42 and 44 or more, therein. Should the user wish to simply cook one item, the device 10 is reconfigurable to the single level cooking configuration of FIG. 1.

As noted, any of the different configurations and components can be employed with any other configuration or component shown and described as part of the device herein. Additionally, while the present roaster oven invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A countertop roaster apparatus for multilevel cooking of food, comprising:
a first housing having a first sidewall surrounding a first cooking cavity;
a second housing having a bottom surface extending to a second sidewall, said bottom surface and said second sidewall surrounding a second cooking cavity;
a lid, said lid having a perimeter edge configured to engage atop either said first sidewall in a position covering said first cooking cavity or atop said second sidewall in a position covering said second cooking cavity;
said countertop roaster configurable to a stacked configuration with said bottom surface of said second housing supported upon an upper perimeter edge of said first sidewall; and
said countertop roaster in said stacked configuration communicating heat from said first cooking cavity to said bottom surface of said second housing and into said second cooking cavity, whereby a first food positioned in said first cooking cavity can be cooked by said heat and a second food in said second cooking cavity can concurrently be cooked by said heat.

2. The countertop roaster apparatus for multilevel cooking of food, of claim 1, additionally comprising:
a support ring having a first side surface opposite a second surface;
an aperture formed in a central portion of said support ring communicating between said first side surface and said second surface;
said first side surface of said support ring configured to engage upon said upper perimeter edge of said first sidewall;
said second surface configured for positioning said bottom surface of said second housing thereon;
said countertop roaster in said stacked configuration having said bottom surface of said second housing supported upon said second surface of said support ring and said first side surface of said support ring positioned on said upper perimeter edge of said first sidewall;
said countertop roaster in said stacked configuration communicating heat from said first cooking cavity through said aperture and to said bottom surface of said second housing and into said second cooking cavity.

3. The countertop roaster apparatus for multilevel cooking of food, of claim 2, additionally comprising:
an annular recess depending into said second surface of said support ring; and
said bottom surface of said second housing being positioned within said annular recess when supported upon said second surface of said support ring.

4. The countertop roaster apparatus for multilevel cooking of food, of claim 2, additionally comprising:
handles positioned in respective handle engagements at opposite ends of said support ring; and
said handles providing grip points for the hands of a user to lift and elevate said support ring with said second housing positioned thereon, above said upper perimeter edge of said first sidewall.

5. The countertop roaster apparatus for multilevel cooking of food, of claim 3, additionally comprising:
handles positioned in respective handle engagements at opposite ends of said support ring; and
said handles providing grip points for the hands of a user to lift and elevate said support ring with said second housing positioned thereon, above said upper perimeter edge of said first sidewall.

6. The countertop roaster apparatus for multilevel cooking of food, of claim 4, additionally comprising:
said handle engagements at opposite ends of said support ring being rotational engagements between said support ring and each respective said handle.

7. The countertop roaster apparatus for multilevel cooking of food, of claim 5, additionally comprising:
said handle engagements at opposite ends of said support ring being rotational engagements between said support ring and each respective said handle.
